(19) United States
(12) Patent Application Publication
(10) Pub. No.: US 2015/0293993 A1
(43) Pub. Date: Oct. 15, 2015

(54) METHOD AND SYSTEM FOR HUMAN ENHANCED SEARCH RESULTS

(71) Applicant: Zafir Anjum, Chico, CA (US)

(72) Inventor: Zafir Anjum, Chico, CA (US)

(21) Appl. No.: 14/680,962

(22) Filed: Apr. 7, 2015

Related U.S. Application Data
(60) Provisional application No. 61/978,890, filed on Apr. 13, 2014.

(51) Int. Cl. G06F 17/30; G06Q 20/10

(52) U.S. Cl. CPC G06F 17/30699; G06F 17/30648; G06Q 20/10

(57) ABSTRACT

A method and system are disclosed to improve the relevance of results, apps, videos, photos, advertisements, or other information to be presented to a user responsive to a user request. A method and system are disclosed for relative ranking of items. Human judgment is used to rank items relative to other items to create relatively ranked pairs. The order in which items such as search results are presented to a user may be affected by relative ranking using relatively ranked pairs.

### CROSS-REFERENCE TO RELATED APPLICATION

This application claims priority and the benefit, under 35 U.S.C. §119(e), of U.S. Provisional Patent Application 61/978,890, filed Apr. 13, 2014.

### FIELD OF INVENTION

The described embodiments relate generally to search results and more specifically to human-enhanced search engines.

### BACKGROUND

A web search engine is a system that is designed to search for information on the World Wide Web. In general search engines help users find information and are often keyword driven systems. Keywords are generated from a user request and matched to target documents, videos, apps, advertisements, etc. The search results are often presented as a list of results sometimes referred to as search engine results pages (SERPs). Most established search engines primarily use algorithmic means to rank the results for any given query with the objective that the most relevant results be listed first. The algorithms used are designed to approximate human judgment and measure indicators that imply relevance to a human user. Some of these indicators of relevance used are the number of keywords in a web page, the number of links to a web page, the anchor texts (link labels) of these links, the name of the domain the web page is hosted on, the content of the Uniform Resource Locator (URL) for the web page and so on.

Search engines are always striving to come up with more relevant results but they have weaknesses and still often display results that are irrelevant to the query or often show the less relevant results before some of the more relevant results. Weaknesses in the search engine algorithms are exploited by black hat search engine optimizers who may use unethical or unapproved means of gaming the search engine results.

Accordingly, there has been a need for improved methods and systems with which to identify results relevant to actual users and the ordering of results by relevance when results are displayed responsive to a user's search query.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

A method and system are disclosed to improve the relevance of search results, apps, videos, photos, advertisements, or other information to be presented to a user responsive to a user request. A method and system are disclosed for relative ranking of items. Human judgment is used to rank items relative to other items to create relatively ranked pairs. The order in which items such as search results are presented to a user may be affected by the relative ranking

When a user discovers a shortcoming with the results presented to the user responsive to a search query, the user can initiate an assessment by submitting a request to remove this shortcoming. The request may include: the search query as a reference group, a result item in the search results as a reference item, and a review item which may be another item in the search results or an item missing entirely from the search results.

Humans are used as assessors. They are presented with instructions and the information submitted by the user. They compare the two items with regard to the search query and score each for relevance. Examples of different type of scoring could be: (better, worse), (more relevant, less relevant), (similar, similar), (83, 67), (3.2, 7.8) etc. In at least one embodiment, the assessors are a subset of the users. The comparative assessment of the review item and the reference item with regard to a reference group form a relevancy triad. The review item and the reference item in the relevancy triad form a relatively ranked pair. The relevancy triads are subsequently used to enhance search results.

This enables use of algorithmically generated results as baseline results which can be enhanced whenever relevant human judged relatively ranked pairs are available. The enhancement in results compared to the baseline results would be a factor of the quality and quantity of associated relevancy triads.

Additional aspects and/or advantages will be set forth in part in the description which follows and, in part, will be apparent from the description, or may be learned by practice of the invention.

### BRIEF DESCRIPTION OF DRAWINGS

FIG. 1 illustrates an example environment in which the systems and methods discussed herein can be implemented.

FIG. 2 is a block diagram of an example environment depicting exemplary components and illustrative operations.

FIG. 3 is a flowchart of a process for conducting assessments.

FIG. 4 is a flowchart of a process for aggregation of assessments.

FIG. 5 is a flowchart of a process for assessment of review items that are initiated by a system.

FIG. 6 is a flowchart of a process for system initiated assessment where review items are divided into groups.

FIG. 7 is a flowchart of a process for a user initiated assessment of a review item.

FIG. 8 is a flowchart of a process for enhancing search results using relative ranking

FIG. 9 is a flowchart or a process for evaluating assessors.

FIG. 10 is a high-level block diagram of an apparatus that may be used to effect at least some of the various operations that may be performed in accordance with the present invention.

### DETAILED DESCRIPTION

Reference will now be made in detail to embodiments of the claimed subject matter, a method and system for human enhanced search results, examples of which are illustrated in the accompanying drawings. While the claimed subject matter will be described in conjunction with the embodiments, it will be understood that they are not intended to be limited to these embodiments. On the contrary, the claimed subject matter is intended to cover alternatives, modifications and equivalents, which may be included within the spirit and scope as defined by the appended claims.

Furthermore, in the following detailed descriptions of embodiments of the claimed subject matter, numerous specific details are set forth in order to provide a thorough understanding of the claimed subject matter. However, it will be recognized by one of ordinary skill in the art that the claimed subject matter may be practiced without these specific details. In other instances, well known methods, procedures, and systems have not been described in detail as not to unnecessarily obscure aspects of the claimed subject matter.

Some portions of the detailed descriptions which follow are presented in terms of procedures, steps, processes, and other symbolic representations of operations on data on computer memory by one or more processing units. They may take the form of electrical or magnetic signals capable of being stored, transferred, combined, compared, and otherwise manipulated in a computer system.

Introduction

Using the claimed subject matter, one approach to improve the relevancy of search results is to enhance the algorithmically derived ranking of the search results with human input on the rankings Consider that for a search query we have a search engine results page (SERP) with results determined and ranked algorithmically according to relevance. The search query may be considered a reference group for each item in the SERP. Suppose we take one of the items, item A, from the SERP and ask a number of humans to compare it, within the context of the search query, to another item, item B, which may or may not be in the SERP. Suppose further that a majority of those asked to compare item A and item B find that item B is more relevant to the search query and should be ranked higher than item A for the search query. That is, the rank of item B relative to item A is higher for the search query. Then we know that even if, for the search query, item A is ranked higher in the SERP or even if item B is missing from the SERP, item B should be included if absent and additionally should be ranked higher than item A to improve the SERP for a human.

The concept of adjusting the rank of an item relative to that of another with regards to a reference group is herein referred to as relative ranking Item A may be considered the reference item and item B may be considered the review item and together along with their relationship they form a relatively ranked pair with regard to the reference group which is the search query in this case. In some embodiments, the relatively ranked pairs also comprise the assessment scores. In some embodiments, when the relevancy of the two items in a relatively ranked pair are of similar relevance based on some given criteria, they may be marked as equi-ranked. In some embodiments, an item in a relatively ranked pair is relatively ranked higher than the other item in the pair only if the difference in their relevancy is above some measurable value. In some embodiments, only those relatively ranked pairs are processed for relative ranking where the review item is relatively ranked higher than the reference item.

In general, each item in a relatively ranked pair may be a set of items wherein each member of the set has the same relationship to the other item of the relatively ranked pair. The relatively ranked pair together with the reference group form a relevancy triad. Similarly we can envision a relevancy tetrad comprised of a reference group, a reference item, a review item relatively ranked higher than the reference item, and a review item relatively ranked lower than the reference item. In essence, a relevancy tetrad is comprised of two relevancy triad, both sharing the reference group and the reference item but having different review items. Various other data structures can be envisioned where relatively ranked pairs are associated with a reference group but whatever the structure they can be broken down into units comprising a relatively ranked pair and a reference group that the pair is associated with.

To illustrate relative ranking with an example, suppose that the top seven results for a search query ‘tiny bird’ is ranked by a search engine as: bird A, bird B, bird C, bird D, bird E, bird F, bird G. It is presumed that the results should be ordered by increasing size of the birds, that is, the tinier birds should be ranked higher on the list of results. If bird B and bird F were compared by a few humans and a majority determined that bird F is tinier than bird B, then bird F has a higher relative rank than bird B with regard to the reference group ‘tiny bird’. Bird B and bird F form a relatively ranked pair where the review item, bird F, is the higher ranked item relative to the reference item, bird B, with regard to the reference group, ‘tiny bird’. Applying relative ranking to the results, enhances the order of the results to: bird A, bird F, bird B, bird C, bird D, bird E, bird G.

If another comparison was made, this time between a bird K, that is not in the top seven results, and bird A, and the majority of the humans who did the comparison determined that bird A was tinier than bird K then further relative ranking of the results would leave the results unchanged because bird A is already ranked higher than bird K, whatever the rank of bird K may be.

If yet another comparison was made and this time between bird K and bird D and a majority of the human assessors who made the comparison determined that bird K as tinier than bird D, then the new relatively ranked top seven results would be: bird A, bird F, bird B, bird C, bird K, bird D, bird E.

It would be observed that each relevancy triad may incrementally enhance the search results by applying relative ranking

When a user discovers a shortcoming with the results presented to the user responsive to a search query, the user can initiate an assessment by submitting a request to remove this shortcoming. The shortcoming may be poor ranking of the results, inclusion of an irrelevant item in the results, omission of a relevant item from the results etc. The request may include: the search query (reference group), a result item in the search results (reference item), and a review item which may be an item missing entirely from the search results or ranking below the reference item.

Humans are used as assessors. They are presented with instructions and the information submitted by the user. They compare the review item and the reference item, then assign scores of relevance to each with regard to the search query. Examples of different types of scoring could be: (better, worse), (more relevant, less relevant), (similar, similar), (83, 67), (3.2, 7.8) etc. In at least one embodiment, the assessors are a subset of the users of the system. The comparative assessment of the review item and the reference item with regard to a reference group form a relevancy triad with the review item and the reference item forming a relatively ranked pair. The relevancy triads are subsequently used to enhance search results.

It should be borne in mind that in an effort to facilitate better understanding of the claimed subject matter, an object may also mean its identifier. This is in concordance with common use, where, for example, when a person says “I am on the waiting list” it means “My name is on the waiting list”. Sometimes both the item and it's identifier are equally appropriate and at other times the context conveys which is preferable. For example, if it says, ‘a web page is received’, it may mean that the actual content of the web page is received or that a link to the web page is received since the link would enable retrieval of the web page content. Similarly, a ‘review item’ may mean the actual item, or an identifier such as a uniform resource locator (URL) pointing to the review item, or some description of creating or composing the review item.

It should also be borne in mind that higher rank signifies superior rank and lower rank signifies inferior rank. So an item ranking 5th has a higher rank than an item ranking 7th but a lower rank than an item ranking 3rd.

Environment

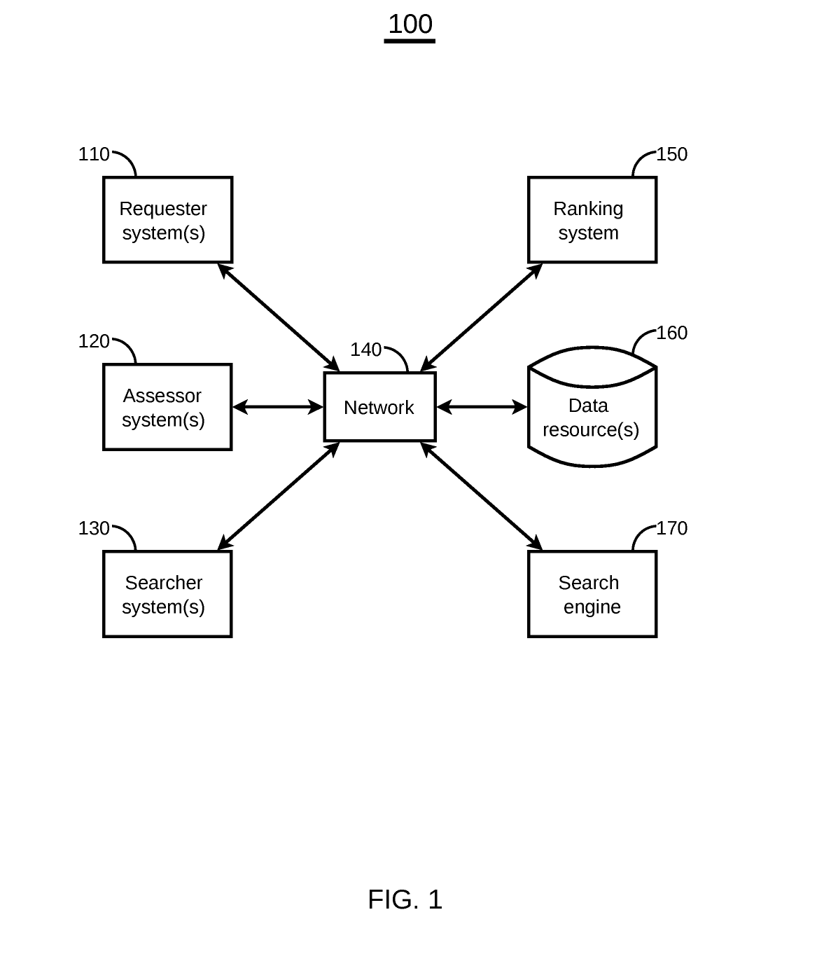

FIG. 1 illustrates an example environment 100 in which the systems and methods discussed herein can be implemented. Environment 100 includes requester system(s) 110, assessor system(s) 120 and searcher system(s) 130. Some example devices that may be used for these end user systems include a smart phone, personal computer, laptop computer, tablet computer, smart television and other types of computing devices. It should be noted that although requester system(s) 110, assessor system(s) 120 and searcher system(s) 130 are shown as distinct, they can be the same physical device. They are shown separately to illustrate the distinct role a system may play. Similarly an individual using requester system(s) 110 may be the same individual using assessor system(s) 120 or searcher system(s) 130 and may have a single registered account.

Environment 100 also includes ranking system 150 and search engine 170 to which the end user systems connect through network 140 such as the Internet or a system bus. It should be noted that labels in the drawings that end in ‘(s)’ represent, for the purpose of illustration, one or more items which are conceptually similar.

A user using requester system(s) 110 initiates an assessment of a review item by sending a request to ranking system 150. Ranking system 150 creates a task and gets assessment done by one or more human assessors using assessor system(s) 120. After receiving at least a predetermined number of assessments for a task, ranking system 150 evaluates ranking information for the review item and saves to data resource(s) 160. A data resource is computer-readable media that is not a transitory, propagating signal.

Users using searcher system(s) 130 query search engine 170 which return results that get ordered by ranking system 150 before being displayed to the user at searcher system(s) 130.

Overview

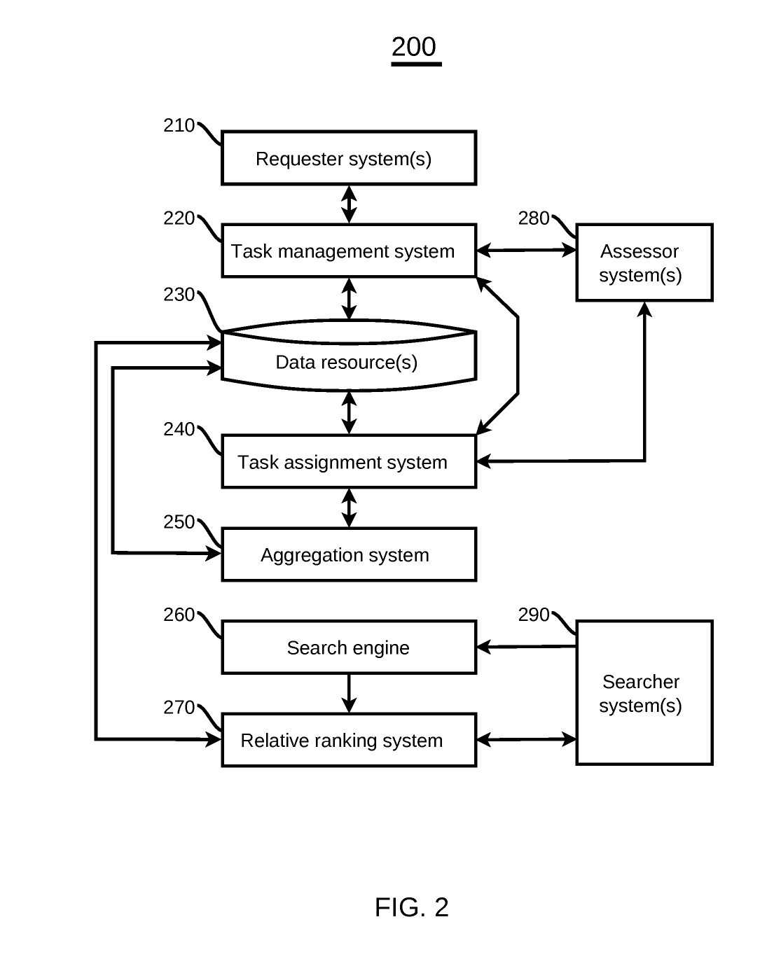

FIG. 2 is a block diagram of another example environment 200 depicting exemplary components and illustrative operations in accordance with various embodiments of the claimed subject matter. Environment 200 shows some of the same blocks as environment 100 and focuses more on the flow of information and data. It should be understood that entities in environment 200 may be connected to other entities through a network or a system bus.

Environment 200 includes one or more end user systems: requester system(s) 210, assessor system(s) 280, and searcher system(s) 290. Environment 200 further includes search engine 260 and data resource(s) 230.

Also included in environment 200 are task management system 220, task assignment system 240, aggregation system 250, and relative ranking system 270. Task management system 220, task assignment system 240, aggregation system 250, and relative ranking system 270 may be independent systems or may be sub systems of one or more systems. For example, ranking system 150 of FIG. 1 may comprise task management system 220, task assignment system 240, aggregation system 250, and relative ranking system 270.

A user (requester) using requester system(s) 210 initiates an assessment of a review item with regard to a reference group. Information provided by the requester using requester system(s) 210 include a reference group, at least one review item and may include one or more of: reference item, payment information, assessment notes, pros and cons pertaining to review item(s), points or credits offered, demographic related criteria, request that assessments be done by experts, and other criteria pertinent to an assessment. The type of a review item or a reference item may include: audio media, visual media, mixed media, mobile app, web app, product, answer, web page, advertisement, search result, URL, domain name, identifier to an object of an allowed type, search resource, category, keyword, search request, query, and profile.

In some embodiments, the requester is a registered user. In some embodiments, the requester should not only be a registered user but also have billing information on record. In some embodiments, the requester has to pay to initiate the assessment. In various embodiments, the requester may not also be an assessor for an assessment the requester initiated.

Task management system 220 receives the review item, the reference group and other information pertaining to the assessment from the requester and does one or more of: create a task, schedule tasks, save task information to data resource(s) 230, track progress of tasks, mark tasks as complete based on the number of assessors having completed a task, reactivate and reschedule a completed task based on given criteria. Task management system 220 also enables a registered user to update any task initiated by the registered user. In some embodiments, task management system 220 adds the task to a regular queue or a priority queue instead of scheduling it and saves the queue to data resource(s) 230.

Data resource(s) 230 provides task information to task assignment system 240, which offers the task to one or more assessors using assessor system(s) 280. An assessor is a user who has been accepted for the task of assessments. In some embodiments, assessors may include registered users. In some embodiments, assessors may be associated with one or more topics in which they are experts. Once an assessor using assessor system(s) 280 accepts a task, task assignment system 240 updates data resource(s) 230 and signals task management system 220.

In some embodiments, an assessor assesses a review item with regard to reference group according to instructions which are given based on the kind of assessment. In some embodiments, when an assessment task includes a reference item then the assessor is asked to compare the review item to the reference item with regard to the reference group and score each item. As part of an assessment task, the assessor may also be asked to give feedback on any pros and cons listed by the requester or other assessors. The assessor may even add to the list of pros and cons. On completion of the assessment, assessor system(s) 280 sends the assessment to task assignment system 240, which updates data resource(s) 230 with the completed assessment and signals task management system 220 and aggregation system 250. For the benefit of other assessors, an assessor may also add notes to a task. This note is passed on to task management system 220 by assessor system(s) 280. In some embodiments, where the tasks are in a queue saved in data resource(s) 230, task assignment system 240 also updates the queue in data resource(s) 230.

Aggregation system 250 aggregates the scores of all assessments for a task. Depending on the assessment request, it creates a relevancy triad and saves to data resource(s) 230. In some embodiments, feedback on any pros and cons associated with the review item may be factored in when determining the relative ranking In some embodiments, the determination of the higher ranked item is also based on how apart the two scores are. If the difference in scores is within a threshold amount, the two items in the relatively ranked pairs are marked as equi-ranked.

When a user using searcher system(s) 290 queries search engine 260, search engine 260 compiles a results set responsive to the query and sends the results set to relative ranking system 270. Relative ranking system 270 ranks the listings in the results set based on the relevancy triads saved in data resource(s) 230 by aggregation system 250. In some embodiments, search engine 260 is also connected to data resource(s) 230 over a network or through relative ranking system 270. In some embodiments, the results of aggregation system 250 are incorporated in the data set used by search engine 260 so the ordering of search results by search engine 260 already accounts for the relative ranking information.

Conducting Assessments

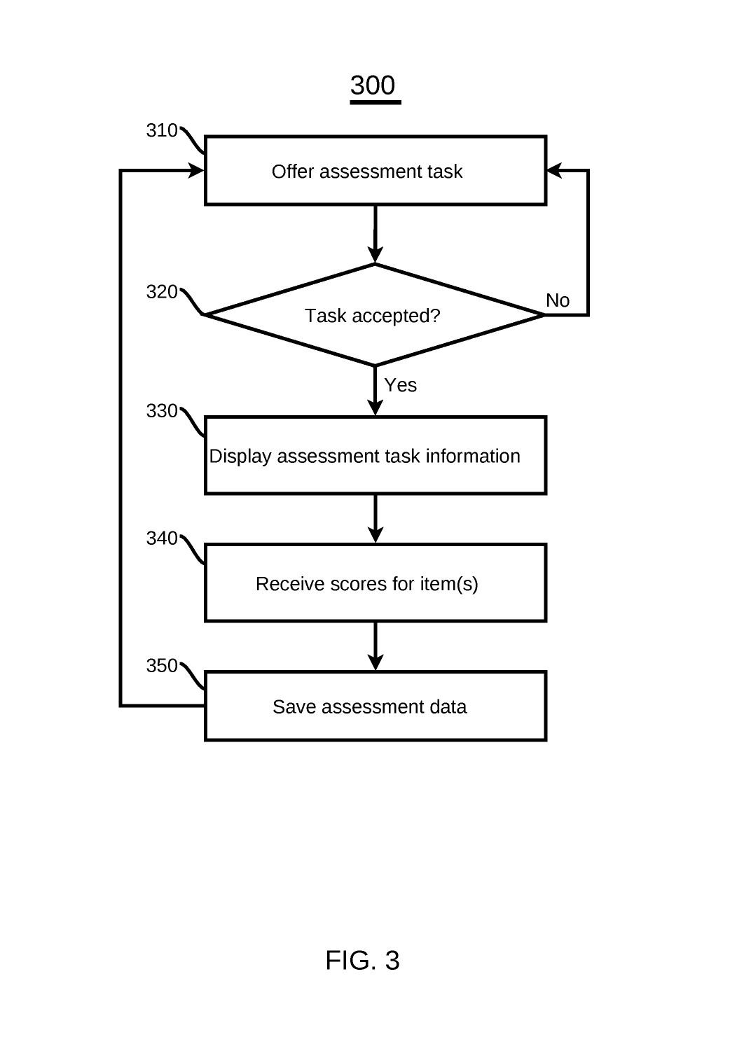

FIG. 3 depicts a flowchart describing a process 300 for conducting assessments. An assessment task asks an assessor to assess and score one or more items with regard to a reference group based on information and criteria given as part of the assessment task. An assessment task may be performed by one or more assessors. In some embodiments, a plurality of assessors have to complete an assessment task before the assessment task is considered completed. In some embodiments, a number is specified for a desired number of assessors who should perform the assessment task. Also, an assessor may perform many assessment tasks.

In some embodiments, an assessment task asks an assessor to compare two or more items to each other with regard to a reference group and assign scores to each item based on a given set of criteria.

The reference group can be a search query, a category, or something that identifies a set of results. The one or more items are members of the reference group or are assumed to be so. In some embodiments, the assessment task includes a reference group and at least two items which include at least one reference item which is known to be a member of the reference group and at least one review item which is assumed to be a member of the reference group. In some embodiments, the reference item may be limited to one of the members of a sub-group of the reference group.

To illustrate with an example, suppose that the reference group is a search term that can be queried on a search engine. Then the results of the search are members of the reference group. The reference item is one of the known results. The review item may or may not be one of the results but it is assumed that it is relevant enough to be one of the results. Going further, suppose that the reference item is limited to a sub-group of the reference group, one such sub-group could be the top 1358 results of the results responsive to the search term in our example. That is, in this example, a reference item may be a result that ranks 1358 or better. In some embodiments, the reference item is limited to a sub group of size 1358 or smaller for performance reason.

In some embodiments, assessors are compensated for completing an assessment task. In some embodiments, assessors are given points or credits for completing an assessment task. Leaderboard of leading assessors can be displayed for motivation.

Steps 310-350 describe exemplary steps comprising the process 300 in accordance with the various embodiments herein described. In step 310, an assessment task is offered to an assessor. An assessor may be a registered user who has been approved for assessment tasks. Next, in step 320, if the assessor declines the task, then step 310 offers a different task to the assessor. If the assessor accepts the task in step 320, then step 330 displays assessment instructions including criteria to base scores on and the objects pertaining to the assessment task. For example, in some embodiments, these assessment pertinent objects are a reference group, a reference item and a review item. In some embodiments, the assessment pertinent objects comprise of a reference group and a review item.

The assessor scores the item(s) based on the criteria provided. In at least one embodiment, the assessor is provided with a plurality of items and instructed to score only a specified smaller number of items than the number of items provided. In some embodiments, assessment scoring comprises of selecting an item from a group of two or more items based on given criteria. In some embodiments, assessment scoring comprises of ordering or ranking a plurality of items based on given criteria.

Then in step 340, the scores for the item(s) are received from the assessor. This completes the assessment task accepted by the assessor and then step 350 saves the assessment data. Step 310 may then offer another assessment task to the assessor.

Some simplified examples are given below with the gist of the instructions that assessors may receive. These examples are meant to illustrate some of the types of assessments and are not meant to be exhaustive or detailed. Assessment items in the next few examples mean the review items and reference items that comprise the assessment task.

### EXAMPLE A

Assessment item(s) to be scored from 0-100 with regard to reference group based on given criteria. A possible result for two assessment items is (Item A:85, Item B:75). A possible result for a single assessment item is (Item:25). A possible result for four assessment items is (Item A:37, Item B:60, Item C:35, Item D:65).

### EXAMPLE B

Assessment item most relevant to reference group based on given criteria to be selected. A possible result for two or more assessment items is (Item X).

### EXAMPLE C

Assessment items to be ordered by decreasing relevancy based on relevancy to reference group. A possible result for three assessment items is (Item B, Item C, Item A).

### EXAMPLE D

Assessment items to be assigned grades A through F based on relevancy to reference group with grade A the most relevant and grade F the least relevant. A possible result for four assessment items is (Item A:B, Item B:B, Item C:A, Item D:F).

### EXAMPLE E

Assessment items to be compared for relevancy with regard to reference group and item B to be scored from 0-b100 if item A is assumed to have a score of 50. A possible result is (Item B:65).

Aggregation Of Completed Assessments

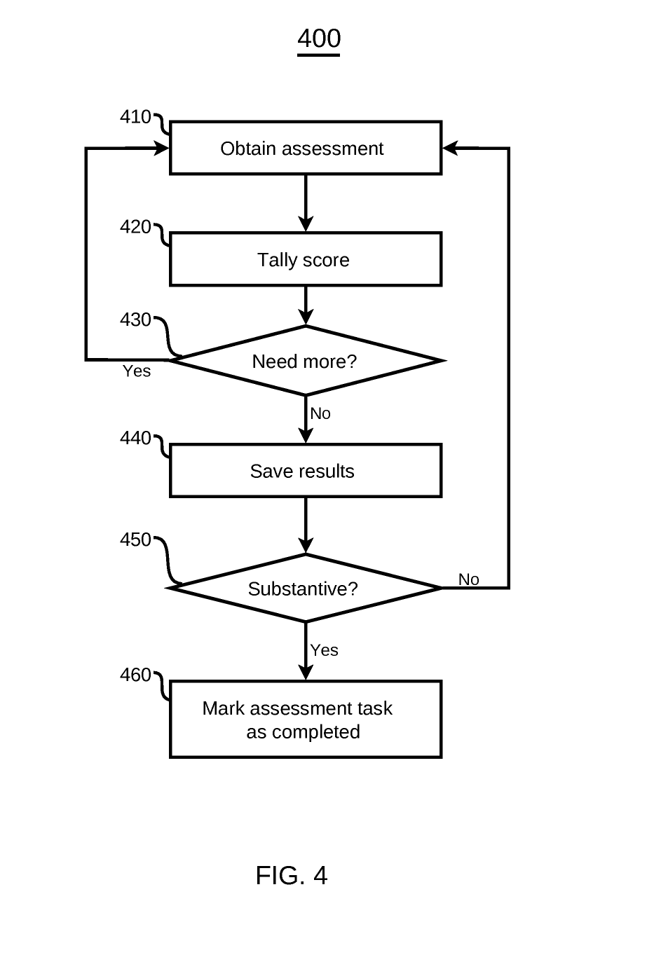

FIG. 4 depicts a flowchart describing a process 400 for aggregation of assessments made by a plurality of assessors responsive to an assessment task. Steps 410-460 describe exemplary steps comprising the process 400 in accordance with the various embodiments herein described.

Process 400 begins with step 410 when an assessment is obtained from a data resource or is received from an assessor. In step 420, the score assigned to item(s) by the assessor are tallied. In step 430, a determination is made as to whether at least a specified number of assessments have been tallied. If a determination is made that more assessments need to be tallied, control flows back to step 410, otherwise control flows to step 440 and the results are saved to a data resource. The results saved in step 440 may include one or more of: the raw data, intermediate processed results, results with various level of processing for different applications, relatively ranked pairs associated with reference groups etc.

In step 450 a determination is made as to whether the results are substantive based on given criteria. If it is determined that the tallied results are not substantive then steps 410-450 are repeated and incrementally more substantive results are saved in step 440. In some embodiments, the determination of substantiveness is made based on the number of assessments that are aggregated. If it is determined that the results are substantive then the assessment task is marked as completed in step 460. In some embodiment, saved results comprise of relatively ranked pairs associated with reference groups.

In some embodiments, determinations made in step 430 or step 450 are based on the number of assessors having completed an assessment task. So, in step 430 if it is determined that more assessments are required to meet a predetermined minimum number of assessors having completed an assessment task, then flow continues to step 410, otherwise flow continues to step 440. Similarly, in step 450, if it is determined that there exists a preferred number of assessors having completed an assessment task and that number has been reached, then flow continues to step 460, otherwise flow continues to step 410. The process continues till in step 460 the assessment task is marked as completed. This may be done by updating a data resource or signaling another system or subsystem.

### SIMPLIFIED EXAMPLE

Suppose that the minimum and the preferred number of assessors required to complete an assessment are both 3. Suppose further that their assessments for a task with reference group G, review item A and reference item B are (G, (A:75, B:66)), (G, (A:65, B:70)) and (G, (A:55, B:45)). Then after the aggregation of the assessments, the saved result could be of the form (G, A, B) which simply means that for the reference group G, item A has a higher relative rank than item B. This can be derived by simply determining the item that was ranked higher by the majority of assessors. The rule or formula used to tally the assessment scores may be based on various factors and can vary in different embodiments.

In some embodiments, the formula used to tally the score is to take the average of the normalized scores with the higher score normalized to 100. In this case, the saved result could be of the form (G, (A:98, B:63)) which indicates that item A is relatively ranked higher than item B for reference group G. The value 98/63 give a measure of strength of the relative ranking Of course, this same information could be encoded in many different ways.

System Initiated Assessments

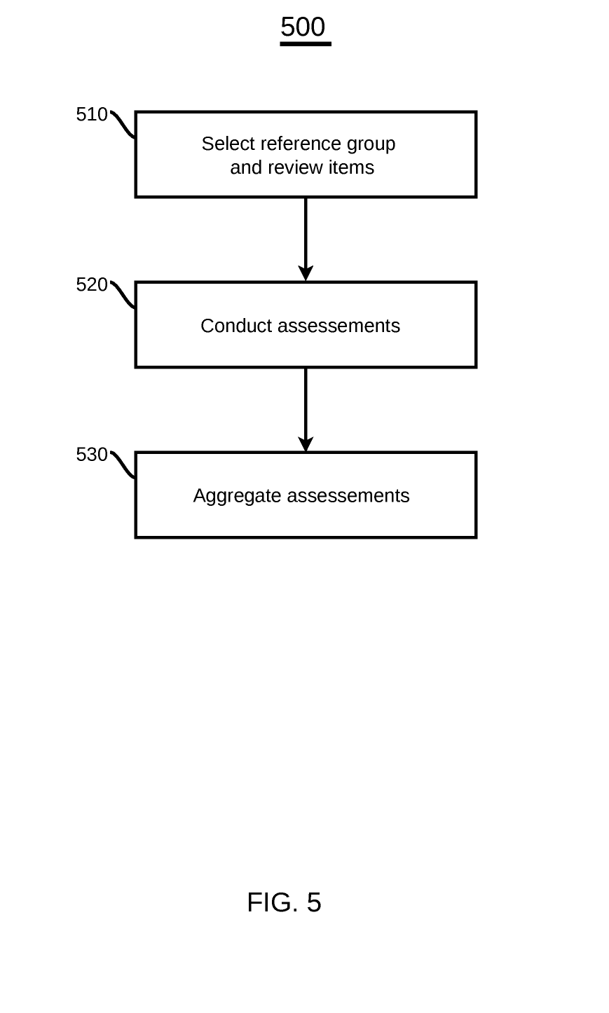

FIG. 5 depicts a flowchart describing a process 500 for a system initiated assessments of review items. Steps 510-530 describe exemplary steps comprising the process 500 in accordance with the various embodiments herein described. In step 510, an assessment task is created by selecting a reference group and one or more review items. The selection of the reference group is based on some criteria such as popularity, trending, new etc. For example, if the reference group is a search term, then the reference group could be a search term that is popular or trending. The review items are members of the reference group and are selected based on some criteria for review items. For example, the criteria for the review items may be that the review items be among the top 30 results of the reference group.

In step 520, assessments are conducted. An exemplary process for conducting assessments is process 300 shown in FIG. 3. In step 530, assessments conducted in step 520 are aggregated. An exemplary process for aggregating assessments is process 400 shown in FIG. 4.

Simplified example: Suppose that ‘cat humor’ is a popular search query and item A and item B are among the results of this search query. The system selects these based on some criteria and initiates an assessment where the reference group is ‘cat humor’ and the review items are item A and item B.

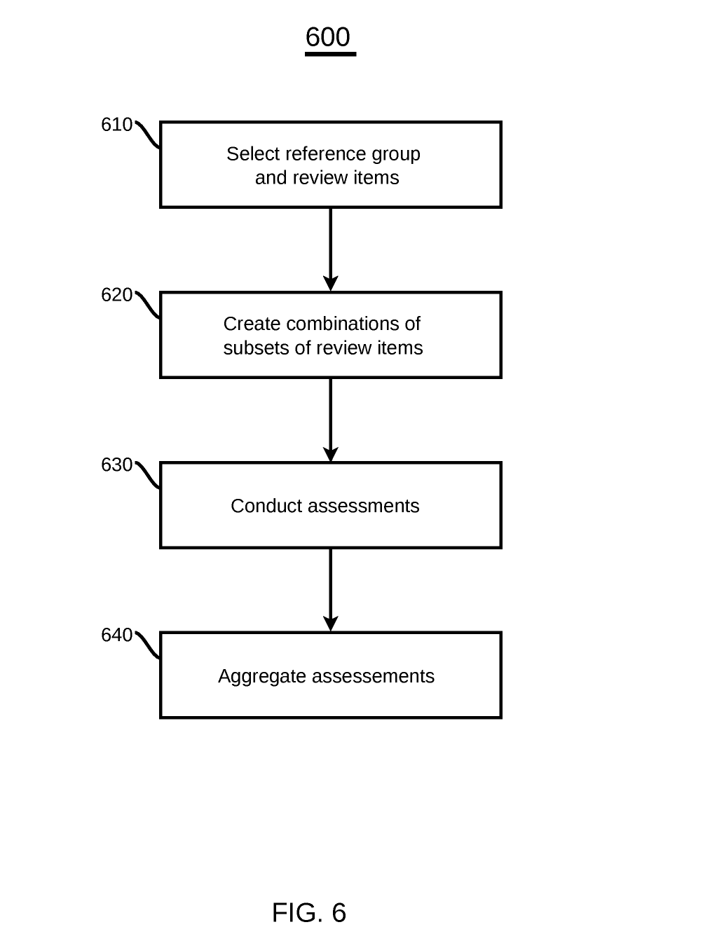

FIG. 6 depicts a flowchart describing a process 600 for a system initiated assessments of review items. Steps 610-640 describe exemplary steps comprising the process 600 in accordance with the various embodiments herein described. In step 610, a reference group is selected and a plurality of review items are selected. Then, in step 620, the set comprising the plurality of review items is divided into combination of subsets and assessment tasks are created for these subsets. Next, in step 630, assessments are conducted for each subset. An exemplary process for conducting assessments is process 300 shown in FIG. 3. Finally, in step 640, assessments conducted in step 630 are aggregated. An exemplary process for aggregating assessments is process 400 shown in FIG. 4.

To illustrate, let us consider an example where, in step 610, the set of selected review items is (A, B, C, D). A combination of subsets created in step 620 can be (A, B, C), (A, B, D), (A, C, D) and (B, C, D). Step 620 creates assessment tasks for each subset. Assessments are conducted in step 630. To continue with the example, suppose that the instructions given to the assessors are to pick two of the review items based on certain criteria and assign scores to those two review items based on certain other criteria. In this example, an assessment task for the subset (A, B, C) can return an assessment in the form (A=65, b=85). In step 640, after aggregating the assessments of all the subsets from all the assessments completed, an example of the aggregate score can be A=70, B=80, C=85 and D=60. The specific structure and values of the data are shown only to illustrate the example and do not imply any limitation.

With each assessment task completed, more relatively ranked pairs are generated or previously generated pairs are updated and thus more information is obtained for enhancing search results using relative ranking

User Initiated Assessments

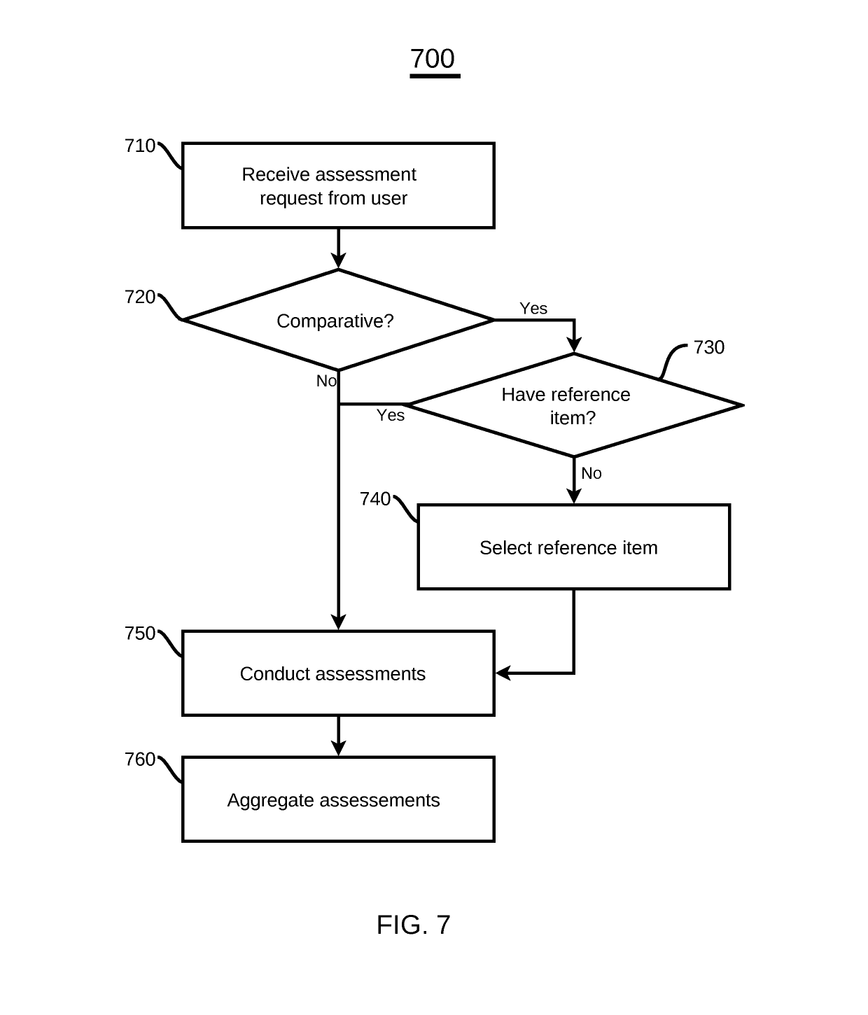

FIG. 7 depicts a flowchart describing a process 700 for a user initiated assessment of a review item. Steps 710-740 describe exemplary steps comprising the process 700 in accordance with the various embodiments herein described. In step 710, an assessment request is received from a user. The assessment request includes a reference group and a review item. In various embodiments, the assessment request also includes one or more of: reference item, initial rank of reference item, assessment notes, arguments in favor of certain actions during assessments, suggested title and snippet, and pros and cons pertaining to the review item. In various embodiments, a payment or an agreement to pay is received with the request. In various embodiments, the assessment request received in step 710 may include assessment criteria pertaining to one or more of: geographic region, device type, gender, age group, and demographic data.

Then, in step 720, it is determined if the assessment request is for a comparative assessment. An assessment is a comparative assessment if an item is assessed relative to another with regard to a reference group. An assessment is non-comparative if an item is assessed and scored with regard to a reference group independent of any other review item or reference item. If the assessment request is for a comparative assessment, operation continues with step 730, else it continues with step 750. In step 730, it is determined if a reference item was received as part of the assessment request and operation continues with step 750 if it was, else it continues on to step 740. If an initial rank of the reference item was received as part of the assessment request, then step 740 selects the item at the given initial rank in the ranked list comprising the reference group as the reference item. Otherwise, step 740 selects a reference item based on predetermined rules. In some embodiments, a reference item having a rank higher than a specified rank is selected. In at least one embodiment, a predetermined rule is to select the last item on the first page of ranked items comprising the reference group. In some embodiments, multiple reference items are selected and steps 750 and 760 are repeated for each combination of review item and reference items.

In step 750, assessments are conducted based on the assessment request. An exemplary process for conducting assessments is process 300 shown in FIG. 3. In step 760, assessments conducted in step 750 are aggregated. An exemplary process for aggregating assessments is process 400 shown in FIG. 4.

In some embodiments, the user initiating the assessment is compensated or awarded points or awarded site credits depending on the outcome of the assessment.

Simplified example: A user initiates an assessment where the assessment request is comprised of the search query ‘mortgage calculator’ as the reference group, item A which is the existing top result in the results responsive to the search query ‘mortgage calculator’ as the reference item and a new mortgage calculator, that the user has just finished creating, as the review item. The assessment request further comprises of notes from the user claiming how the new mortgage calculator (review item) uses the latest mortgage rates and is thus better. In this case the steps involved would be steps 710, 720, 730, 750 and 760. Operation does not involve step 740 since a reference item was already provided by the user. In step 750, the assessors will be asked to compare the new mortgage calculator (review item) to the mortgage calculator which is the existing top result (reference item) and provide assessment scores for both based on relevancy with regard to the search query ‘mortgage calculator’ (reference group). One possible result in step 760 is that the new mortgage calculator receives a higher relative rank than the existing top result for the term ‘mortgage calculator’.

Enhanced Search Results Using Relative Ranking

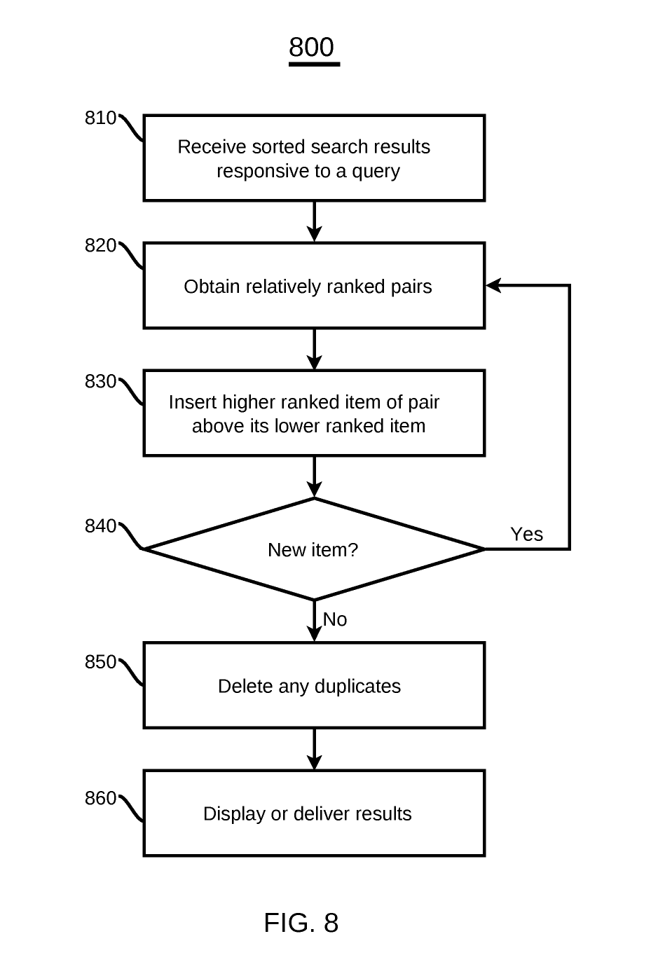

FIG. 8 depicts a flowchart describing an exemplary process 800 for enhancing search results using relative ranking Steps 810-860 describe exemplary steps comprising the process 800 in accordance with the various embodiments herein described. In step 810, search results responsive to a search query are received from a search engine. The search results may be sorted by the search engine based on various criteria.

Then, in step 820, relatively ranked pairs are obtained from data resource(s) matching the condition that the reference group associated with the relatively ranked pairs is the same as the search query and that the lower ranked items of the relatively ranked pairs are existent in the search results. In some embodiments, only a predetermined number of the top ranked search results are considered when obtaining the relatively ranked pairs to reduce the amount of processing. For example, in some embodiments, only the first 1358 results may be considered.

Next, in step 830, the higher ranked item from each of the relatively ranked pairs is inserted just before the occurrence, within the search results, of the lower ranked item of the pair. This creates an updated results list. If there are a plurality of relatively ranked pairs that have the same lower ranked item, then all the higher ranked items of the pairs get inserted into the updated results list at a higher rank than the lower ranked item of the pair. Some embodiments have rules for the order in which the higher ranked items of a plurality of relatively ranked pairs that share the same lower ranked item are inserted in the updated results superior to the rank of the lower ranked item.

Then, in step 840, a determination is made whether any new item was inserted by step 830. If a new item was inserted control flows to step 820, otherwise control continues to step 850.

In step 850, duplicate results from the updated results list are removed, leaving the higher ranked result of any set of identical results. In various embodiments, the updated results list is trimmed to the original size or to a predetermined size, e.g., 1000 results. Then, in step 860, the enhanced search results are delivered to another system for further processing or are displayed.

It should be noted that process 800 is only an exemplary process and one of several ways to enhance search results using relative ranking Processes with different algorithms can be used to get the same results using relatively ranked pairs.

Simplified example: Suppose a previously conducted assessment as discussed in the example for FIG. 7 resulted in a relevancy triad where the reference group is the search query ‘mortgage calculator’ and the higher ranked item of a relatively ranked pair is the new mortgage calculator and the lower ranked item is item A. In step 810, consider that the search query is ‘mortgage calculator’ and the top result is item A. Step 820, would retrieve the relatively ranked pair we just discussed in the previous sentence. Going through the process we would end up with an updated results list where the new mortgage calculator is the top ranked item with item A at second place.

Assessor Evaluation

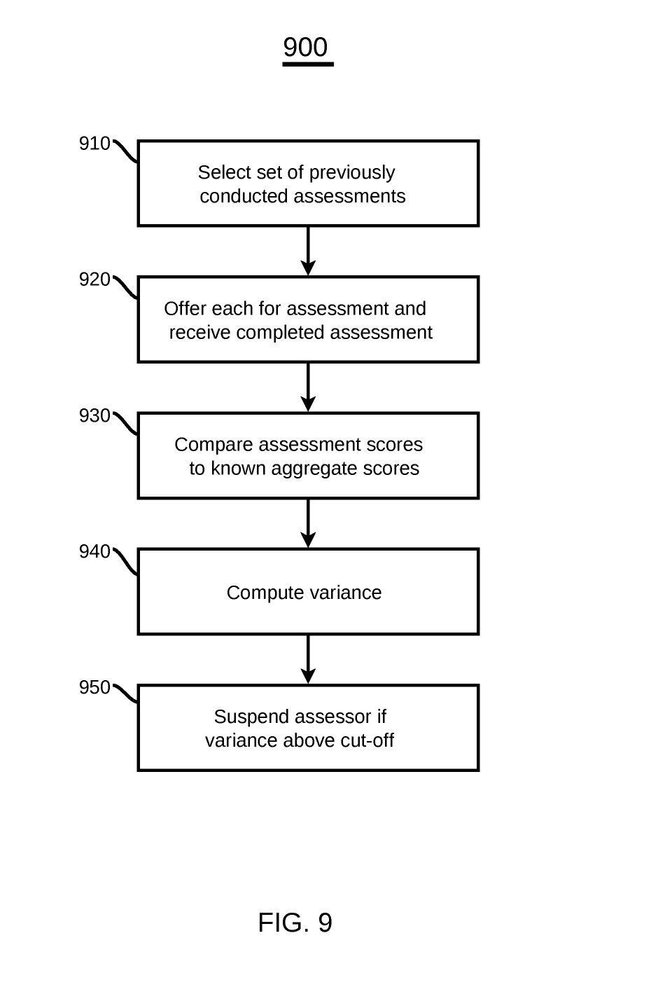

FIG. 9 depicts a flowchart describing a process 900 for evaluating assessors. Steps 910-950 describe exemplary steps comprising the process 900 in accordance with the various embodiments herein described. In step 910, a set of previously conducted assessments is selected. The number of assessments selected can be based on the average time it took to complete each one. Other criteria for selection can be based on how old an assessment is and how many assessors had previously completed the assessment.

In step 920, each of the selected assessments is offered to the assessor being evaluated and scores for each completed assessment is received from the assessor. In step 930, the set of received scores are compared to the known aggregate scores of the set of assessments. In step 940, a variance is computed. If the variance is above a cut-off, then in step 950, the assessor is suspended and the assessors account is updated indicating the suspension in data resource(s) holding account.

Page Removal And Site Demotion

Various embodiments include a method and system for removing a review item from a reference group. A request is received from a requester to remove a review item from a reference group. Assessments are conducted. A plurality of assessors, based on relevancy of the review item with regard to the reference group, submit their assessments to the system. An aggregation step aggregates the scores submitted by the assessors. If the aggregate score of the review item is low, then the review item is deemed irrelevant and marked for removal from the reference group. Either the data resource(s) used by the system generating the reference group is updated or the review item is dynamically removed when the results for the reference group is generated. For example, if one of the results for the search term ‘history of money’ is the movie Jerry Maguire, then the assessments may indicate that the relevance of Jerry Maguire with regard to ‘history of money’ is low and Jerry Maguire may be removed from the results.

Various embodiments include a method and system for demoting items associated with a review item from groups similar to a reference group. For example, if assessors are asked to assess a web site related to financial health for the search term ‘health care’, they will find that the web site has very low relevance to the search term ‘health care’. The system, after receiving a request for demotion and conducting the assessment and aggregating the scores may mark the site for demotion for search terms similar to ‘health care’ like say ‘health care and health benefits’. If a search for ‘health care problems’ includes a result from the web site related to financial health, then it's ranking would be lower than what it originally was before the assessments. In some embodiments, the extent to which ranking is lowered is based on the aggregate score and the original rank of the item associated with the review item.

In some embodiments, the assessment tasks for removal or demotion are added to a queue different from those, if any, for other kinds of assessments. In some embodiments, the requester is compensated if the aggregate of assessments agree with the request. The form of compensation may include one or more of financial instruments, points and credits. In some embodiments, payments are received from requester.

Title And Snippet Update

Various embodiments include a method and system for updating title and snippet of a review item when displaying it as a result of listing a reference group. The system, after receiving a request for review of title and snippet for a review item with regard to a reference group, conducts an assessment to determine if the new title and snippet are indicative of the review item and if it is relevant to the reference group. If the aggregate score of the assessments is above a cutoff mark, the new title and snippet are stored in data resource(s) and any subsequent listing of results with regard to the reference group uses the new title and snippet to display the review item.

In some embodiments, the purpose of the assessment may include determination of relative rank of the review item relative to a reference item as exemplified in other parts of this document. In some embodiments, the updated results are passed on to other system(s) or subsystem(s) instead of displaying them.

Info Bubble

Some search engine queries can be answered with just a simple answer and it adds to the convenience of the searcher if that answer is available on the search results page itself. An info bubble is considered content that attempts to convey the salient information regarding a search term or a reference group. For example, a search for ‘weather in London’ on such a search engine would result in a page that has an info bubble above the rest of the search results that conveys what the weather in London is like at that moment.

Various embodiments include a method and system for selecting an info bubble with regard to a reference group and displaying it responsive to a search for the reference group. The system, after receiving a request for review of an info bubble (the review item in this case) with regard to a reference group, conducts an assessment to determine if the review item is relevant to the reference group and if it is, is it more relevant than the most relevant existing info bubble. If the aggregate score of the assessments indicate an affirmative on both counts, then the review item is marked as the selected info bubble and any subsequent search for the reference group will include this selected info bubble.

In some embodiments, the assessment tasks for info bubble are added to a queue different from those, if any, for other kinds of assessments. In some embodiments, the requester is compensated if the aggregate of assessments agree with the request. The form of compensation may include one or more of financial instruments, points and credits. In some embodiments, payment is required from requester.

Related Search Suggestions

In a manner similar to the method and system for selecting an info bubble, various embodiments include a method and system for selecting search suggestion with regard to a reference group and displaying it responsive to a search for the reference group. The system, after receiving a request for review of a related search suggestion (the review item in this case) with regard to a reference group, conducts an assessment to determine if the review item is relevant to the reference group and if it is, is it more relevant than the most relevant existing related search suggestion. If the aggregate score of the assessments indicate an affirmative on both counts, then the review item is marked as the selected related search suggestion and any subsequent search for the reference group will include this selected related search suggestion. In some embodiments, a plurality of related search suggestions are provided and the review item may be assessed for relative ranking in relation to one or more of the most relevant related search suggestions. The system would then determine based on the aggregation the assessments whether the review item should be included with the results for a search of the reference group and if so, at what position.

For example, for a search query ‘mortgage calculator’ (reference group), a suggested related search can be ‘mortgage lender’ (review item).

Comparative Elevated Ranking

Various embodiments include a method and system for elevating ranks of items associated with a review item relative to items associated with a reference item in groups similar to a reference group. The review item and the reference item may be one of the types: domain name, a pattern to identify the URLs of a web site, a username, a group of apps or a group of some other items. For example, if assessors are asked to assess a web site, site A, related to legal help compared to another web site, site B, for the search term ‘legal help’, they may find that site A is more relevant.

The system, after receiving a request for comparative assessment and conducting the assessment and aggregating the scores saves a relevancy triad comprising of the reference group, the reference item and the review item. For example, the system may mark site A for elevated ranking with respect to site B for search terms similar to ‘legal help’ like say ‘legal help resources’. If a search for ‘legal help resources’ include a result from site B and a result from site A with the former at a higher rank, then the system may elevate the rank of the result from site A by a few places depending on the aggregate score of the assessments and the rank of the result from site B. The maximum elevation in rank due to any single relevancy triad is limited to one place better than the result from the lower ranked item of the relatively ranked pair of the relevancy triad.

In some embodiments, the assessment tasks for rank elevation are added to a queue different from those, if any, for other kinds of assessments. In some embodiments, the requester is compensated if the aggregate of assessments agree with the request. The form of compensation may include one or more of financial instruments, points and credits. In some embodiments, payments are received from requester.

Personalized Elevated Ranking

Various embodiments include a method and system for elevating ranks of items associated with a preferred item relative to items associated with a reference item in groups similar to a reference group. This provides for personalized elevated ranking The system receives a request from the searcher consisting of at least a preferred item, a reference item, and a reference group and saves it to data resource(s) for subsequent personalization of search results for the searcher.

An illustrative example is given. There are many topics where many similar websites serve the topic. For example, if there's a house for sale and a searcher queries the search engine providing it the address of the house, the results responsive to the search may include results from many different real estate listings web sites.

A searcher may have a clear preference for one web site over another for a particular topic and may specify these preferences to the system. For example, the searcher may specify that ‘zillow.com’ should be elevated with reference to ‘yetanotherrealestatesite.com’ by up to five places for ‘real estate’ related searches. This would then have the effect of elevating the rank of a result from ‘zillow.com’ if it is ranked below a result from ‘yetanotherrealestatesite.com’ for any search related to ‘real estate’. The number of places that the rank may be elevated would be at most five (as specified by the searcher in this example) and at most one place better than the result from ‘yetanotherrealestatesite.com’. If on the other hand, the result from ‘zillow.com’ already ranked higher than that from ‘yetanotherrealestatesite.com’ then no elevation in rank occurs.

Crowd Sourced Relevancy Triads

Various embodiments include a method and system for determination of relevancy triads. The system receives proposed relevancy triads from a plurality of users. If the system receives identical relevancy triads from a large number of users, the system may make the determination to mark the relevancy triad as valid and to subsequently use it for relative ranking In some embodiments, the system also takes account of the number of opposite triads where the relationship between the relatively ranked pair is reversed. In one example embodiment, if a system receives a relevancy triad T from more than a hundred users and the number of opposite triads received is less than ten percent the number of relevancy triad T, then the system marks relevancy triad T as valid.

User Interface

Various embodiments include a user interface component to easily submit assessment requests or user suggested relevancy triads. In one embodiment, there is a button displayed next to each search result displayed to a user responsive to a search query, clicking which sends one or more suggested relevancy triads to the system. For example, the button adjoining a result item may be labeled ‘Better than previous’, clicking which will submit a relevancy triad with the search query as the reference group, the search result adjoining the button as the review item with a higher suggested rank and the item one rank higher than the review item as the reference item. In some embodiment, this triggers an assessment while in other embodiments a plurality of users making the same submission is used to create crowd sourced relatively ranked pairs. It should be noted that the user interface component may take other forms and be activated by other user actions such as touching it or swiping the item if the device the results are displayed on is a touch enabled device. The user interface component does not require any entry of text to cause submission of the requested assessment or the suggested relevancy triad. In some embodiments, activating the user interface component further causes personalized elevated ranking.

Consider another example where the user interface component is a button adjoining a result item labeled ‘Best Result’. A user clicking this will cause a plurality of suggested relevancy triads to be submitted, each with the search query as the reference group and the item adjoining the button as the review item but each triad having one of the remaining result items as the reference item.

Some embodiments include a touch gesture component on a touch interface to easily submit assessment requests or suggested relevancy triads. Executing a configurable gesture will directly submit assessment request or suggested relevancy triads, causing the system to save the submitted data in a data resource and subsequently incorporating it into relative ranking decisions. For example, a user may swipe up with a finger on a touch interface and without lifting the finger swipe left to submit a suggested triad based on the previous search query executed by the user and the search result being viewed.

Some embodiments include a visual gesture component on a visual interface to easily submit assessment requests or suggested relevancy triads. Some embodiments comprise of camera(s) and/or infrared detector(s) to detect the gestures. Executing a configurable gesture will directly submit assessment request or suggested relevancy triads, causing the system to save the submitted data in a data resource and subsequently incorporating it into relative ranking decisions. For example, a user may move a hand up and then left to submit a suggested triad based on the previous search query executed by the user and the search result being viewed.

Preprossessing and Post-Processing

Previously, in this document, an embodiment was described where search engine results were obtained and then re-ranked using relative ranking This is post-processing of the search engine results. In some embodiments, search engine data may be updated to incorporate the ranking information available through the relevancy triads and the search engine results directly passed on to users. In some embodiments, relative ranking may be delegated to user systems by sending executable code with the results set. One example of such executable code is Javascript instructions sent to a browser on user systems.

Exemplary Apparatus

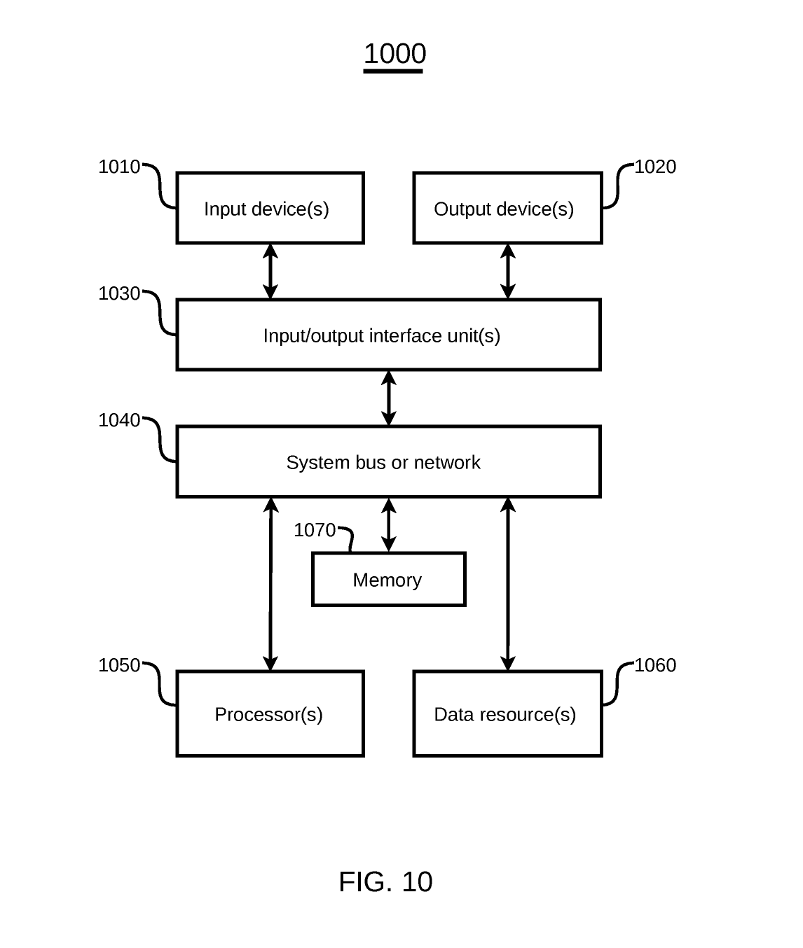

FIG. 10 is a high-level block diagram of apparatus 1000 that may be used to effect at least some of the various operations that may be performed in accordance with the claimed subject matter. The apparatus 1000 includes, inter alia, processor(s) 1050, input/output interface unit(s) 1030, data resource(s) 1060, memory 1070 and system bus or network 1040 for facilitating the communication of information among the coupled elements. Input device(s) 1010 and output device(s) 1020 may be coupled with input/output interface(s) 1030.

Processor(s) 1050 may execute machine-executable instructions to effect one or more aspects of the claimed subject matter. At least a portion of the machine executable instructions may be stored (temporarily or more permanently) in memory 1070 and/or on data resource(s) 1060 and/or may be received from an external source via input/output interface unit(s) 1030.

In one embodiment, apparatus 1000 may be one or more conventional personal computers. In this case, processor(s) 1050 may be one or more microprocessors. System bus or network 1040 may include a system bus, the Internet, wide area network, local area network, wireless network etc. Data resource(s) 1060 is capable of providing storage for the apparatus 1000. In one implementation, data resource(s) 1060 is a non-transitory computer-readable medium. In various different implementations, data resource(s) 1060 can include, for example, a hard disk device, an optical disk device, a storage device that is shared over a network by multiple computing devices (e.g., a cloud storage device), or some other large capacity storage device. Memory 1070 stores information within the apparatus 1000. In one implementation, the memory 1070 is a computer-readable medium. In one implementation, the memory 1070 is a volatile memory unit. In another implementation, the memory 1070 is a non-volatile memory unit.

A user may enter commands and information into the personal computer through input device(s) 1010, such as a keyboard and pointing device (e.g., a mouse) for example. Other input devices such as a microphone, a joystick, a game pad, a scanner, a touch surface, or the like, may also (or alternatively) be included. These and other input devices are often connected to processor(s) 1050 through an appropriate interface 1030 coupled to the system bus 1040. However, in the context of some operation(s), no input devices, other than those needed to accept queries, and possibly those for system administration and maintenance, are needed.

Output device(s) 1020 may include a monitor or other type of display device, which may also be connected to the system bus 1040 via an appropriate interface 1030. In addition to (or instead of) the monitor, the personal computer may include other (peripheral) output, such as speakers and printers for example.

In various embodiments, apparatus 1000 can be a device such as mobile computing devices, mobile communication devices, set-top box television client devices, etc.

Although an example apparatus has been described in FIG. 10, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results.

1. A computer-implemented method for user initiated assessment, comprising:
receiving, from a user, an assessment task that comprises a reference group, a reference item, and a review item, wherein said reference item belongs in said reference group;
conducting assessments pertaining to said assessment task using one or more human assessors;
receiving, by a processor, scores indicative of their assessments from said assessors; and
saving said scores in a data resource as data structures comprising relevancy triads.

2. The method of claim 1, wherein said reference group is a search query and said reference item is one of the results responsive to said search query.

3. The method of claim 2, further comprising receiving payment from said user.

4. The method of claim 3, wherein said reference item is ranked better than 1358 in the results responsive to said search query.

5. The method of claim 2, further comprising making a payment to at least one of said assessors.

6. The method of claim 5, wherein said payment is based on attributes of the assessor said payment is made to.

7. The method of claim 2, wherein said assessors are selected using criteria based on factors comprising an assessor's location, device used by an assessor for assessments, an assessor's assessment history, and attributes of said assessment task.

8. The method of claim 2, further comprising:
obtaining results responsive to said search query; and
reordering said results based on relevancy triads.

9. The method of claim 8, wherein said reordering is done by a server device.

10. The method of claim 8, wherein said reordering is done by a client device.

11. The method of claim 2, further comprising saving, in a data resource, aggregate of said scores as data structures comprising relevancy triads.

12. The method of claim 1, further comprising receiving payment from said user.

13. The method of claim 12, further comprising saving, in a data resource, aggregate of said scores as data structures comprising relevancy triads.

14. The method of claim 12, wherein said reference item is ranked better than 1358 in said reference group.

15. The method of claim 1, wherein said reference item is ranked better than 1358 in said reference group.

16. The method of claim 15, wherein said review item is not ranked first in said reference group.

17. A computer-implemented method for improving search results comprising:
receiving, by a processor, a search query;
obtaining ordered results responsive to said search query;
obtaining, from a data resource, relevancy triads wherein the reference groups comprised by said relevancy triads correspond to said search query; and
reordering said results based on relatively ranked pairs comprised by said relevancy triads.

18. The method of claim 17, further comprising adding to said results at least one item comprised by said relevancy triads.

19. The method of claim 17, further comprising discarding at least one of the lowest ranked results from said ordered results obtained responsive to said search query.

20. A computer system configured to perform a method according to claim 3.
